(19) United States
(12) Patent Application Publication
(10) Pub. No.: US 2006/0157947 A1
(43) Pub. Date: Jul. 20, 2006

(54) Method of skate board identification

(76) Inventor: Gabor Paulovits JR., San Leandro, CA (US)

Correspondence Address: QUINE INTELLECTUAL PROPERTY LAW GROUP, P.C., P O BOX 458, ALAMEDA, CA, 94501, US

(21) Appl. No.: 11/299,282

(22) Filed: Dec. 7, 2005

Related U.S. Application Data
(63) Continuation-in-part of application No. 10/665,659, filed on Sep. 19, 2003, now Pat. No. 7,004,504.

(51) Int. Cl. B62M 1/00

(52) U.S. Cl. 280/87.042

(57) ABSTRACT

Skateboard wheels and skate wheels having cover plates. The cover plates can be mounted to a wheel body of the wheel using a press fit, adhesives, connectors, and the like. The mounting can be through positioning contact of a cover plate neck region with a wheel body inner shoulder.

### CROSS-REFERENCE TO RELATED APPLICATIONS

This application is a Continuation in Part (CIP) from, and claims priority to and benefit of, a prior U.S. Utility application Ser. No. 10/665,659, Method of Skate Board Identification, by Gabor Paulovits, Jr., filed Sep. 19, 2003. The full disclosure of the prior application is incorporated herein by reference.

### FIELD OF THE INVENTION

The present invention is in the field of skate and skateboard wheels and wheel covers. Wheel covers are mounted to wheel bodies to present a protective and attractive wheel display surface.

### BACKGROUND OF THE INVENTION

Various hubcaps have been designed for wheels of skates and skate boards. Generally, these hubcaps are continuous flat disks mounted to the skate axle or wheel periphery. These hubcap inventions may protect the axle from dirt, but can interfere with access to the axle or conflict with the resilience response of the wheel to obstacles in the road.

In U.S. Pat. No. 2,392,634 Ornamental Skate Wheel, to Bierman (1946), the outer edge of the skate wheel near the rolling surface has recessed inner threads to receive a threaded mounting ring to hold a decorative hubcap disk. The disk can be attractive and prevent dirt from soiling the bearings inside the wheel. However, the mounting near the outer rolling surface of the wheels is unsuitable for many modern resilient skate wheels. For example, the contortion of modern polyurethane wheels under the stresses of extreme sports would conflict with the peripheral mounting fixtures of Bierman. In addition, the flat outer surface may protrude too far from the wheel and fails to reflect light in a range of directions.

In U.S. Pat. No. 4,511,182, Skate Wheel Cover, to Birnham, the threaded end of the skate axle extends into the exposed wheel well of the skate wheel. A tubular sleeve of the skate wheel cover is inserted onto the nut in an interference fit relationship to frictionally secure the skate wheel cover to the axle. The cover does not turn with the wheel. A clearance is required between the cover and wheel to prevent interference between the parts.

In U.S. Pat. No. 3,883,180, Wheel Hub Cap for Skate Wheels, to Kain, a hubcap is mounted to the periphery of a skate wheel outside surface using 2-sided adhesive tape. A central sleeve protrudes inward to pop off the cap if the axle nut becomes loosened. Again, this hubcap has the problems of peripheral mounting and difficult axle nut access.

In view of the above, a need exists for covers suitable for modern skate or skateboard wheels that are resilient and experience the stress of current extreme sports. Benefits could be realized from wheel covers that do not conflict with axle nut access and inspection. It would be desirable to have wheel covers that conform to the shape of modern wheels instead of just covering them up. The present invention provides these and other features that will be apparent upon review of the following.

### SUMMARY OF THE INVENTION

The present invention includes skate board wheels and skate wheels having useful and decorative cover plates. The cover plates can cover the entire outer face of the wheel and be mounted to the wheel body at a relatively central (axial) location. The cover plates can reveal some of the wheel body or axle for access or decorative purposes.

In a preferred embodiment, the cover plate is mounted to the wheel body through interaction of a cover plate neck region with a wheel body inner shoulder. For example, wheel for skates or skateboards can include a wheel body with a bore running axially between two faces, and having an outside surface and an inner shoulder on at least one of the faces. The cover plate can include a display surface and an inner neck region adapted to make close positional contact with the wheel body inner shoulder. The cover plate can be mounted with the neck region associated with a complimentary wheel body inner shoulder so that the display surface covers a portion of the wheel body outside surface.

In another embodiment, the wheel face and cover plate are not flat, but include three dimensional topography. The cover plate also includes a central hole. For example, the wheel for skates or skateboards can include a wheel body with a bore running axially between two faces, and at least one of the faces having a substantially concave or convex outside surface. The cover plate includes an inner edge around a central hole, a display surface, and a back surface. The wheel body face and complimentary cover plate back side surface can be mated with the back surface being convex if the face is concave or the back side surface being concave if the face is convex. The cover plate can be mounted to the wheel body with the back surface in contact or closely adjacent to the wheel body face.

Cover plates can mount to the wheel body. The mounting can be through interactions closer to the axle rather than near the outer edge of the cover plate. In a preferred embodiment, the cover plate has a neck region that projects toward or into the wheel body when it is mounted. The neck region can be mounted inside the inner shoulder or on the outside of an inner shoulder. The cover plate can be mounted at the neck region using a press-fit configuration, an adhesive, a two-sided tape, heat bonding, threaded mounts, pins, screws, and/or the like.

The cover plates are typically about 2 inches in diameter. Particularly for in-line skates, cover plates can be mounted on both sides of the wheels, e.g., on each of the two wheel body faces. Cover plates can have an inner neck region for centering and mounting in association with a wheel body inner shoulder. The cover plate can have an inner edge around a central hole, e.g., at the neck region, or the cover plate can continue across the inner neck region. The cover plate display surface can be ornamented, e.g., with perforations, appliqués, corporate logos, trademarks, engravings, textures, painted designs, and/or the like.

The wheel body can be a standard or modified skateboard wheel or skate wheel. In typical embodiments, the wheel body has a diameter of about 3 inches or less. The wheel body can have one or more recesses in the bore adapted to functionally receive standard 21 mm bearing sets. The wheel body can have an inner shoulder to receive a cover plate neck region allowing the cover plate to be mounted to the wheel body with the neck region in contact with the inner shoulder.

### DEFINITIONS

Unless otherwise defined herein or below in the remainder of the specification, all technical and scientific terms used herein have meanings commonly understood by those of ordinary skill in the art to which the present invention belongs.

Before describing the present invention in detail, it is to be understood that this invention is not limited to particular devices or recreational systems, which can, of course, vary. It is also to be understood that the terminology used herein is for the purpose of describing particular embodiments only, and is not intended to be limiting. As used in this specification and the appended claims, the singular forms “a”, “an” and “the” include plural referents unless the content clearly dictates otherwise. Thus, for example, reference to “a component” can include a combination of two or more components; reference to “a user” can include two or more users, and the like.

Although many methods and materials similar, modified, or equivalent to those described herein can be used in the practice of the present invention without undue experimentation, the preferred materials and methods are described herein. In describing and claiming the present invention, the following terminology will be used in accordance with the definitions set out below.

The term “skateboard”, as used herein, refers to a recreational device comprising a low platform mounted over four wheels, and powered into motion by a rider standing on the platform, as is known by one skilled in the art. “Skates” as used herein, include sporting equipment, such as older fashion roller skates and in-line skates, well known and understood by those skilled in the art.

The term “positioning contact”, as used herein, refers to the interaction between a cover plate neck region and wheel body inner shoulder. Positioning contact includes contact between a neck region surface and an inner shoulder surface at two or more points. Positioning contact is preferably between three or more points, and most preferably a substantially continuous contact along mated circumferences. The “contact” can be direct or optionally through another media such as a tape, adhesive, or the like. The positioning contact can function to position the cover plate (e.g., centered) on the wheel body, and/or to mount the cover plate to the wheel body.

### BRIEF DESCRIPTION OF THE DRAWINGS

FIG. 1 shows a schematic diagram of an exemplary wheel mounted to a skate board axle.

FIG. 2 shows a schematic diagram of a cover plate press-fit mounted to a wheel body.

FIGS. 3A to 3C show variations on mounting interactions between cover plate neck regions and wheel body inner shoulders.

FIGS. 4A and 4B show schematic diagrams of wheel embodiments and dimensions.

### DETAILED DESCRIPTION

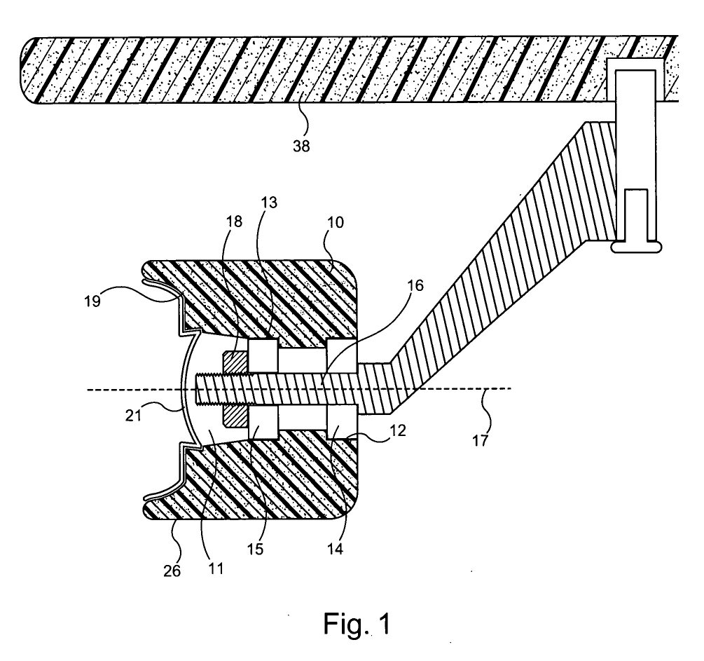

Wheels of the invention are suitable for installation on typical skateboards and skates. The wheels can be mounted to skates and skateboards in any suitable fashion. Typically, as shown in FIG. 1, the wheel body 10 can have a bore 11 with an inner recess 12 and outer recess 13 to receive an inner bearing set 14 and outer bearing set 15. A skateboard axle 16 can run through the center bore axis 17 of the wheel and bearings, with the whole assembly being held together by axle nut 18. In the present invention, a wheel cover plate can be mounted to the wheel body over all or part of the wheel body face 19.

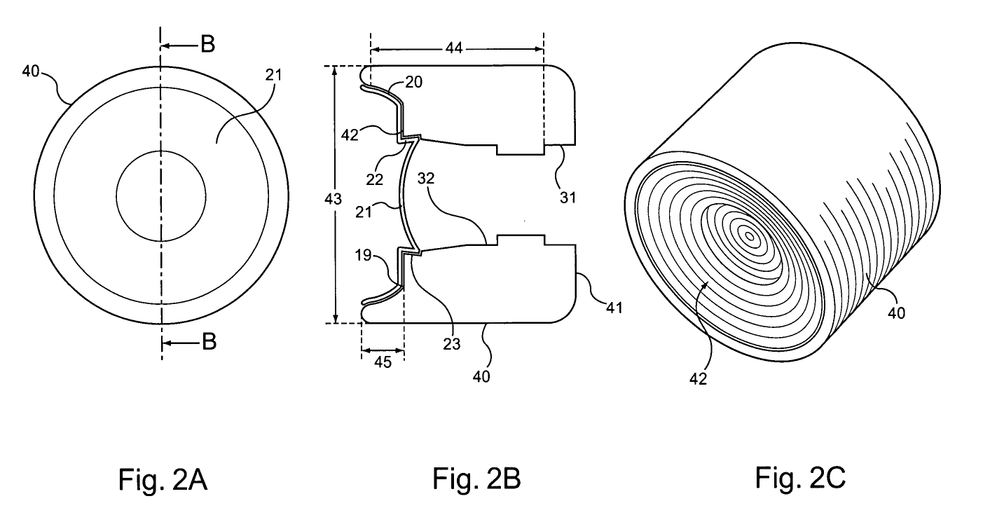

For example, in one embodiment, as shown in FIGS. 2A and 2B, the back side 20 of cover plate 21 has contours that compliment the contours of the wheel body face 19. The cover plate is mounted to the wheel body bore. An inner neck region 22 of the cover plate is adapted to fit in close contact with an inner shoulder 23 of the wheel body.

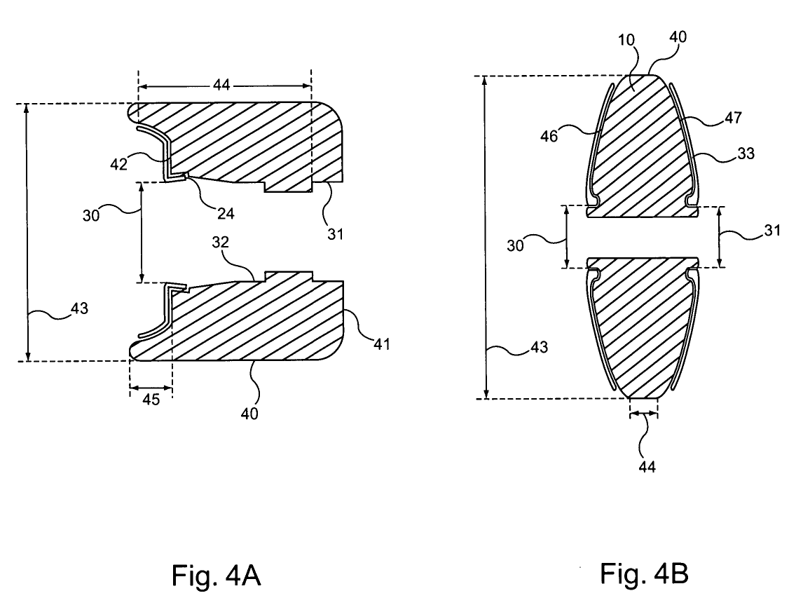

In an optional aspect of the invention, the neck region 22 comprises an inner edge 24 around a central hole of diameter 30, as shown in FIG. 4A. The presence of the central hole in the cover plate allows easy inspection and manipulation of the axle nut, e.g., without removal of the cover plate.

In many embodiments, the contours of the cover plate back side match the contours of the associated wheel body face. As shown in FIG. 2B, when the wheel body face 19 is concave, the cover plate back side 20 can have a complimentary convex shape, so the two shapes form a complimentary fit. Alternately, as shown in FIG. 4B, when the wheel body face 47 is convex, the cover plate back side 33 can have a complimentary concave shape.

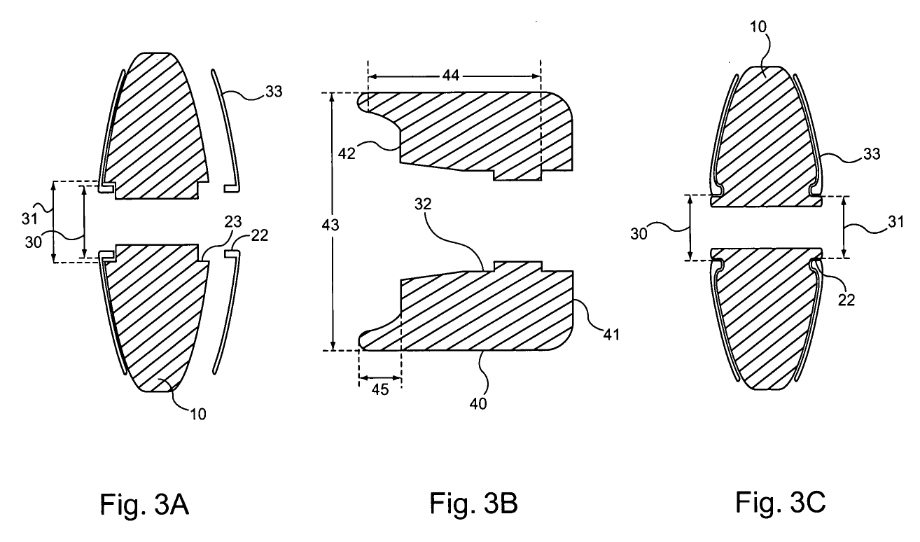

In preferred embodiments, the cover plate is mounted or centered, at least in part, by interaction between a cover plate neck region and a wheel body inner shoulder. This interaction is typically a close positioning fit between matching cylindrical or conical surfaces. For example, as shown in FIG. 3A, a neck region 22 of the cover plate can have a diameter 30 slightly smaller than the diameter 31 of an inner shoulder 23 of the wheel body 10, e.g., so the cover plate can be held, centered and mounted to the wheel body. (The figures show a clearance to aid in understanding the description. In many embodiments the surfaces are in light contact having about the same diameters, or contacting in an interference fit with the neck region diameter slightly greater than the inner shoulder diameter.) In another example, as shown in FIG. 3C or 4B, the a neck region 22 can have a contact surface diameter 30 slightly greater than the contact surface diameter 31 of an inner shoulder 23, e.g., so the neck region fits around the inner shoulder to provide mounting functions. Alternately, the neck region contact surface can be the same or less that the inner shoulder contact surface, e.g., providing frictional mounting or a resilient compression mounting force.

Wheel Bodies

The wheel body of the invention can be, e.g., a standard skateboard wheel or a wheel adapted for certain embodiments of the invention. For example, the wheel of the invention can be a standard skate wheel modified, e.g., to have an inner shoulder or certain face surface contours.

The wheel body can be fabricated as a single piece of material, or can be a composite. The wheel body can be, e.g., a single piece of injection molded polyurethane. Optionally, the wheel body can be a composite, e.g., of a softer frictional polyurethane or rubber outer rolling surface over an inner core of harder honeycombed plastic material. The rolling surface can provide a smooth ride with enhanced traction while the inner core can be light but strong for interactions with mounting hardware. The wheel body can be made from, e.g., polyurethane, polypropylene, block copolymers, rubber, polycarbonate, nylon, carbon composites, ceramics, metals, and/or the like. In a preferred embodiment, the core is manufactured separately by injection molding with a hard plastic (e.g., polyethylene or acetyl), then the rolling surface material, typically polyurethane, is cast over the core.

Wheel bodies can provide surfaces and/or fittings adapted to cooperate with wheel cover plates for fixed mounting. Typically, for roller skate and skate board wheels, the outside face (e.g., the surface generally perpendicular to the center bore axis and visible looking from the side of a skateboard to which they may be mounted) of the wheel body is configured to receive a cover plate, while the unseen inner face (toward the proximal end of the axle) has a flat contour without mounting surfaces. By contrast, the wheel bodies of many in-line skates are viewable in use from either side (first or second sides; left or right sides) and will typically have mounting surfaces and/or fixtures on both sides.

The wheel bodies can have mounting surfaces or fittings adapted to one or more mounting schemes. For example, wheel body faces can simply conform to the shape of a cover plate back side, so the plate can be mounted frictionally, with a press-fit, by 2-sided tape, by adhesives, etc. Optionally, the wheel body face or bore can include holes to receive screws or bolts. The wheel body inner shoulder can have threads to receive corresponding threads present in a cover plate neck region.

Wheel bodies are typically cylindrical with substantially flat, concave, and/or convex face surfaces, as described above. The wheel bodies can be standard or modified skate or skateboard wheels. As shown generally for skateboard wheels in FIG. 4A, the wheel body can include rolling surface 40, inner face 41, and outer face 42. The rolling surface diameter 43 can range, e.g., from about 4 inches to about 1 inch, from about 3 inches to about 1.5 inches, less than about 2.5 inches or about 2 inches. The rolling surface width 44 can range from about 3 inches to less than 0.5 inches, from about 2 inches to about 1 inch, or about 1.5 inches. The inner and outer bearing recesses are typically about 21 mm in diameter to receive standard bearing sets, but this can vary. In some embodiments, the outer face is concave and recessed a distance 45 from about 1 inch to about 0.1 inch, from about 0.5 inches to about 0.25 inches, or about 0.35 inches, e.g., to allow recessed mounting of the cover plates. For in-line skate wheels, as shown, e.g., in FIG. 4B, the wheel body can include rolling surface 40, first face 46, and second face 47. The rolling surface diameter 43 can range, e.g., from about 6 inches to about 1 inch, from about 4 inches to about 2 inches, or about 3 inches. The rolling surface width 44 can range from about 2 inches to less than 0.2 inches, from about 1.5 inches to about 0.75 inches, or about 1 inch. In many cases the rolling surface of in-line skate wheels are rounded surfaces. In most embodiments of wheels for in-line skates, the faces are convex and covers are mounted on both sides.

Cover Plates

Cover plates of the invention can have a display surface and a back side surface. The cover plates can be mountable to wheel bodies with the back side directed to a face surface of the wheel body and the display surface directed away from the wheel body. In preferred embodiments, the cover plate is mounted with support or centering from a cover plate neck region. In certain preferred embodiments, the back side of the cover plate closely conforms to the shape of the associated wheel body face surface. In many embodiments, the cover plates are not mounted to the wheel body near the outer edge and/or in the middle region between the outer edge and center of the plate, although they can optionally be mounted at those locations.

The display surface of a cover plate can be decorated with informative or visually appealing designs. For example, the display surface can be ornamented with textures, paint, perforations, appliqués, corporate logos, engravings, trademarks, and/or the like. The texture in a metal cover plate can provide reflection angles that provide a sparkling effect as the cover turns in light. Two or more paint colors can contrast so the rate of turning is more apparent to viewers. The designs can include radially progressive graphic trends (such as spirals) to provide the illusion of a moving image. Perforations can add contrast and can allow wheel body surfaces behind the cover plate to be viewed. The perforations can also function to allow access to wheel mounting hardware. The perforations can be holes or slits of various shapes, such as, e.g., circles, diamonds, ovals, slits, and/or the like.

The display surface of a cover plate can have a three-dimensional shape. In some embodiments, the display surface of a cover plate can be flat, e.g., with the cover plate being essentially a flat disk in a single plane. Optionally, the cover plate can have a non-flat shape, e.g., being concave and/or convex at various locations along the surface so that the display surface is not in a single plane. In a preferred embodiment for skate boards and traditional (2+2) skates, the cover plate has a concave bowl shape (as seen looking at the display surface) that allows the back side to fit into a matching recess in a wheel body. In a preferred embodiment for in-line skates, the cover plate has a convex dome shape that allows the back side to fit closely adjacent to a convex wheel body face surface.

The cover plates can have a neck region that interacts with a wheel body inner shoulder, e.g., in a mounting or centering positioning contact with a wheel body inner shoulder. For example, the neck region can be a ring or cylinder shaped region projecting axially to be received in a frictional or press fit interaction with a complimentary wheel inner shoulder surface. In one embodiment, the outer surface of the cover plate neck region (surface away from the wheel axis) contacts an inner surface on the wheel body inner shoulder, e.g., as shown in FIG. 4A. Optionally, the inner surface (surface facing the wheel axis) can contact an outward facing surface of the wheel body inner shoulder, e.g., as shown in FIG. 4B. The mounting interaction can include intermediate glue or adhesive systems. The mounting interaction can be by press fitting, e.g., wherein the contacting surfaces include complimentary interfitting conical shapes that tend not to release the cover from the body. For example, the outer edge of the inner shoulder (make of resilient material) can have a narrower diameter than the outer edge of the neck region, e.g., as shown in FIG. 4A, so the neck region can be forced past and captured by the outer edge of the inner shoulder, as is appreciated in the art. Various connectors can optionally be used to mount the cover plate to the wheel body. For example, screws, bolts, or threaded interactions, and the like can be used to hold the cover plate, e.g., at inner locations of the wheel body face, such as the inner shoulder or body core. In preferred embodiments, the mounting device is removably mounted, e.g., for easy access to the axle nut (alternately, axle nut access can be through a central hole in the cover plate).

In preferred embodiments, the cover plate back side surface closely conforms to the wheel body face surface to fit closely adjacent. For example, in the case of in-line skates, close fitting cover plates can avoid interference with the wheel mounting truck hardware and avoid contact with the ground during hard cornering. Closely adjacent fitting can be, e.g., in actual contact over substantially the entire back side surface or contacting a significant part, or with the surfaces less than about 0.1 inches, less than about 0.01 inches, or less than about 0.01 inches apart over substantially the covered area or a significant part of the outer surface area covered by the cover plate. Optionally, the cover plate can extend away from the wheel body, e.g., with significant differences in contours and a substantial space between the cover plate and the wheel face. Spaced cover plates can have an interesting appearance and can avoid interference with resilient wheel body contortions during high impact maneuvers.

Cover plates can be made from any appropriate materials, but preferred materials are strong and durable. Cover plates can be formed from metals, such as aluminum, steel, copper, silver, titanium, etc. Cover plates can be made from plastics, such as polypropylene, polyurethane, polycarbonate, etc.

Cover plates can be manufactured by any suitable technique, e.g., depending on the materials and intended run volume. In one embodiment, concave or convex cover plates are manufactured by stamping and die punching operations from sheet metal. Optionally, the cover plates can be cut with saws, lasers, high pressure hydraulic streams, etc. Inexpensive cover plates can be produced by injection molding or cutting from plastic.

Cover plates can have dimensions suitable to cover all or part of a wheel body face. Cover plates are typically thin plates with uniform thickness, but can vary in thickness depending on, e.g., the desired surface shape, clearances from other skate board hardware, and the type of material. For example, cover plates can have a thickness of more than an inch (e.g., on outer wheel faces or where the cover is inset deeply into the wheel body). Cover plates can have a thickness of about 0.025 inches or less (e.g., in cramped quarters, such as in-line skate trucks). Cover plates can range in thickness from about 1 inch to about 0.005 inches, from about 0.25 inches to about 0.01 inches, from about 0.1 inches to about 0.03 inches, or about 0.25 inches. The cover plates can have an outer diameter of about the outer (rolling surface) diameter of the wheel body or only a small proportion of the wheel body diameter. For example, the cover plates can have an outer diameter ranging from about 100% to about 5% of the associated wheel body diameter, from about 95% to about 10%, from about 90% to about 50%, from about 80% to about 60%, or about 75%. The cover plates can cover from view from about 100% to about 5% of the wheel body outer surface over which it is mounted, 95% to about 10%, from about 90% to about 50%, from about 80% to about 60%, or about 75% coverage. The cover plates can range in diameter from more than about 4 inches to less than about 0.5 inches, from about 3 inches to about 1 inch, from about 2.5 inches to about 1.5 inches, or about 2 inches. In preferred embodiments for skateboards, the cover plate can have a diameter of less than about two inches. In preferred embodiments for in-line skates, the cover plate can have a diameter of less than about three inches.

### EXAMPLE

The following example is offered to illustrate, but not to limit the claimed invention.

Punched Sheet Metal Cover Plates

Concave cover plates for skateboard wheels were prepared by stamping and die punching them from sheet metal stock.

Dies with mated concave and convex surfaces were prepared on a lathe for mounting in a 45-ton Minster punch-press. A ribbon of 0.025 inch thick aluminum sheet metal was fed into the punch-press from a spool. As the ribbon progressed through the machine, it was stamped between the progressive dies into a domed shape having a neck region. The ribbon was also cut by the dies to punch a center hole from the neck region and to punch the outer circumference to free the domed cover plates from the ribbon.

The stamped and punched cover plates were deburred on motorized grinding wheels before mounting on wheel bodies configured to receive them. The wheel bodies were formed from an injection molded polyethylene core, which was in turn covered with a more frictional and resilient polyurethane rolling surface. The wheel body outer surface included donut-shaped concavity to closely receive the cover plate. The cover plate neck region could fit snuggly into an inner shoulder recess of the wheel body for centering and mounting.

It is understood that the examples and embodiments described herein are for illustrative purposes only and that various modifications or changes in light thereof will be suggested to persons skilled in the art and are to be included within the spirit and purview of this application and scope of the appended claims.

While the foregoing invention has been described in some detail for purposes of clarity and understanding, it will be clear to one skilled in the art from a reading of this disclosure that various changes in form and detail can be made without departing from the true scope of the invention. For example, many of the techniques and apparatus described above can be used in various combinations.

All publications, patents, patent applications, and/or other documents cited in this application are incorporated by reference in their entirety for all purposes to the same extent as if each individual publication, patent, patent application, and/or other document were individually indicated to be incorporated by reference for all purposes.

What is claimed is:

1. A wheel for skates or skateboards, the wheel comprising:
a wheel body comprising a bore running axially between two faces, at least one of the faces comprising an outside surface and an inner shoulder; and,
a cover plate comprising an inner neck region adapted to make positioning contact with the wheel body inner shoulder, and comprising a display surface;
wherein the cover plate is mounted at the neck region to the wheel body inner shoulder with the display surface covering a portion of the wheel body outside surface.

2. The wheel of claim 1, wherein the wheel body outside surface is substantially concave or convex.

3. The wheel of claim 2, wherein the cover plate further comprises a convex back side when the outside surface is concave, or further comprises a concave back side when the outside surface is convex.

4. The wheel of claim 1, wherein the neck region is mounted inside the inner shoulder or outside the inner shoulder.

5. The wheel of claim 1, wherein cover plate is mounted at the neck region using a mount selected from the group consisting of: a press fit, an adhesive, a two-sided tape, heat bonding, threaded mounts, pins, and screws.

6. The wheel of claim 1, wherein the wheel body further comprises a diameter of about 3 inches or less, or the cover plate further comprises a diameter about 2 inches or less.

7. The wheel of claim 1, wherein a separate cover plate is mounted to each of the two wheel body faces.

8. The wheel of claim 1, wherein the display surface comprises ornamentation selected from the group consisting of: perforations, appliqués, corporate logos, trademarks, engravings, textures, and painted designs.

9. The wheel of claim 1, further comprising one or more recesses in the bore adapted to functionally receive 21 mm bearing sets.

10. The wheel of claim 1, wherein the inner neck region comprises an inner edge around a central hole of the cover plate or wherein the cover plate is continuous across the inner neck region.

11. The cover plate of claim 1, adapted to be mounted to the wheel body with a back surface in contact or closely adjacent to the outside surface.

12. A wheel for skates or skateboards, the wheel comprising:
a wheel body comprising: a bore running axially between two faces, at least one of the faces comprising a substantially concave or convex outside surface; and,
a cover plate comprising: an inner edge around a central hole, a display surface, and a back side surface; the back surface being convex if the surface of the at least one face is concave or concave if the surface is convex;
wherein the cover plate is mounted to the wheel body with the back surface in contact or closely adjacent to the outside surface.

13. The wheel of claim 12, wherein the wheel body further comprises: an inner shoulder, and the cover plate further comprises a neck region surrounding the central hole; whereby the cover plate can be mounted to the wheel body with the neck region in positioning contact with the inner shoulder.

14. The wheel of claim 12, wherein cover plate is mounted to the wheel body using a mount selected from the group consisting of: a press fit, an adhesive, a two-sided tape, heat bonding, threaded mounts, pins, and screws.

15. The wheel of claim 12, wherein the wheel body further comprises a diameter about 3 inches or less, or the cover plate further comprises a diameter about 2 inches or less.

16. The wheel of claim 12, wherein a separate cover plate is mounted to each of the two wheel body faces.

17. The wheel of claim 16, wherein each of the two faces are convex.

18. The wheel of claim 12, wherein the display surface comprises ornamentation selected from the group consisting of: perforations, appliqués, corporate logos, engravings, textures, trademarks, and painted designs.

19. The wheel of claim 12, further comprising one or more recesses in the bore adapted to functionally receive 21 mm bearing sets.

20. The cover plate of claim 12, comprising an inner neck region adapted to make positioning contact with an inner shoulder of the wheel body.
